(19) United States
(12) Patent Application Publication
(10) Pub. No.: US 2026/0060868 A1
(43) Pub. Date: Mar. 5, 2026

(54) Footrest

(71) Applicant: Upper Echelon Products LLC, AUSTIN, TX (US)

(72) Inventor: Grigory Alexandrovich Markov, Nizhny Novgorod (RU)

(21) Appl. No.: 18/821,956

(22) Filed: Aug. 30, 2024

Related U.S. Application Data
(63) Continuation-in-part of application No. 29/959,592, filed on Aug. 27, 2024.

(51) Int. Cl. A61G 13/12; A61G 13/00

(52) U.S. Cl. CPC A61G 13/125; A61G 13/009; A61G 13/1285

(57) ABSTRACT

An article of manufacture includes an upper portion having a first top surface and a first bottom surface. The first top surface and the first bottom surface meet at a first edge having a front side and back side. The top surface comprises a first lobe and a first interstitial portion. The first lobe and the first interstitial portion extend from the front side of the first edge to the back side of the first edge.

### RELATED APPLICATIONS

This application claims the priority benefit of U.S. Patent Application No. 29/959,592, filed Aug. 27, 2024.

### FIELD AND BACKGROUND OF THE INVENTION

Embodiments of the inventive subject matter generally relate to the field of ergonomics and, more particularly, to footrests.

There is a large variation of body shapes, sizes, and proportions among the general population, meaning that a one-size-fits-all approach to ergonomics tends to miss a large portion of the population. And while it may not be possible to optimize for everyone in the general population, adjustable ergonomic devices, including footrests, can offer support and relief for a larger number of people than static designs.

### BRIEF DESCRIPTION OF DRAWINGS

FIG. 1 is a top front perspective view of an upper portion of a footrest, according to some implementations.

FIG. 2 is a top rear perspective view of an upper portion of a footrest, according to some implementations.

FIG. 3 is a top view of an upper portion of a footrest, according to some implementations.

FIG. 4 is a top view of an upper portion of a footrest, according to some implementations.

FIG. 5 is a top view of an upper portion of a footrest, according to some implementations.

FIG. 6 is a top view of an upper portion of a footrest, according to some implementations.

FIG. 7 is a front view of an upper portion of a footrest, according to some implementations.

FIG. 8 is a back view of an upper portion of a footrest, according to some implementations.

FIG. 9 is a back view of an upper portion of a footrest, according to some implementations.

FIG. 10 is a left side view of an upper portion of a footrest, according to some implementations.

FIG. 11 is a bottom rear perspective view of an upper portion of a footrest, according to some implementations.

FIG. 12 is a bottom view of an upper portion of a footrest, according to some implementations.

FIG. 13 depicts a top rear perspective view of a bottom portion of a footrest, according to some implementations.

FIG. 14 depicts a bottom rear perspective view of a bottom portion of a footrest, according to some implementations.

FIG. 15 depicts a top view of a lower portion of a footrest, according to some implementations.

FIG. 16 depicts a top view of a lower portion of a footrest, according to some implementations.

FIG. 17 depicts a top front perspective view of an upper portion and lower portion of a footrest, according to some implementations.

FIG. 18 depicts a top front perspective view of an upper portion of a footrest placed on a lower portion of the footrest, according to some implementations.

### DETAILED DESCRIPTION

The description that follows includes one or more example embodiments of footrests that embody the present inventive subject matter. However, it is understood that the described embodiments are examples and that specific implementations may vary while still embodying the inventive subject matter described herein.

A footrest may include an upper portion and a lower portion. The upper portion of the footrest may comprise a contoured top surface and a planar bottom surface. The bottom surface may include one or more hemispherical indentations. The lower portion of the footrest may comprise a top surface, a bottom surface, and a side surface extending between an edge of the top surface and an edge of the bottom surface. The top surface of the bottom portion may include one or more hemispherical protrusions configured to mate with the one or more hemispherical indentations in the bottom surface of the upper portion.

The upper portion of the footrest and the lower portion of the footrest may be used together by placing the upper portion onto the lower portion, increasing the height of the upper portion. The upper portion of the footrest and the lower portion of the footrest may also be used independently of each other, with the lower portion operating as a physical therapy device or the like.

When the hemispherical protrusions on the top surface of the lower portion mate with the hemispherical indentations in the bottom surface of the upper portion, the hemispherical protrusions/indentations may operate as a retaining mechanism that prevents secures the upper portion on the lower portion.

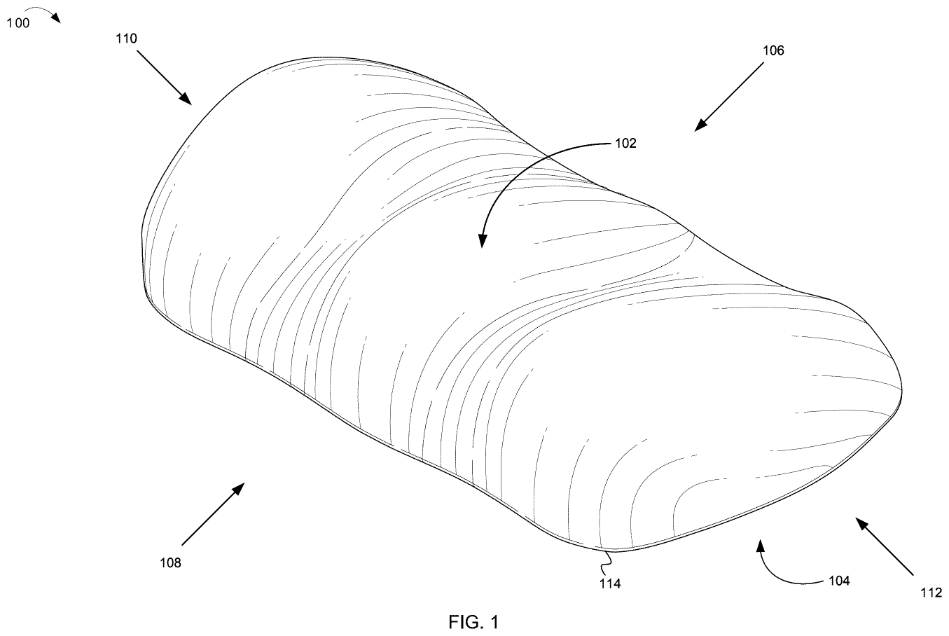

FIG. 1 is a top front perspective view of an upper portion of a footrest, according to some implementations. FIG. 1 depicts the upper portion of a footrest 100 (“upper portion 100”). The upper portion 100 is defined by a top surface 102 and a bottom surface 104. The top surface 102 is contoured and meets the bottom surface 104 at an edge 114 that forms a perimeter of the upper portion 100. The upper portion 100 has a back side 106, a front side 108, a right side 110, and a left side 112.

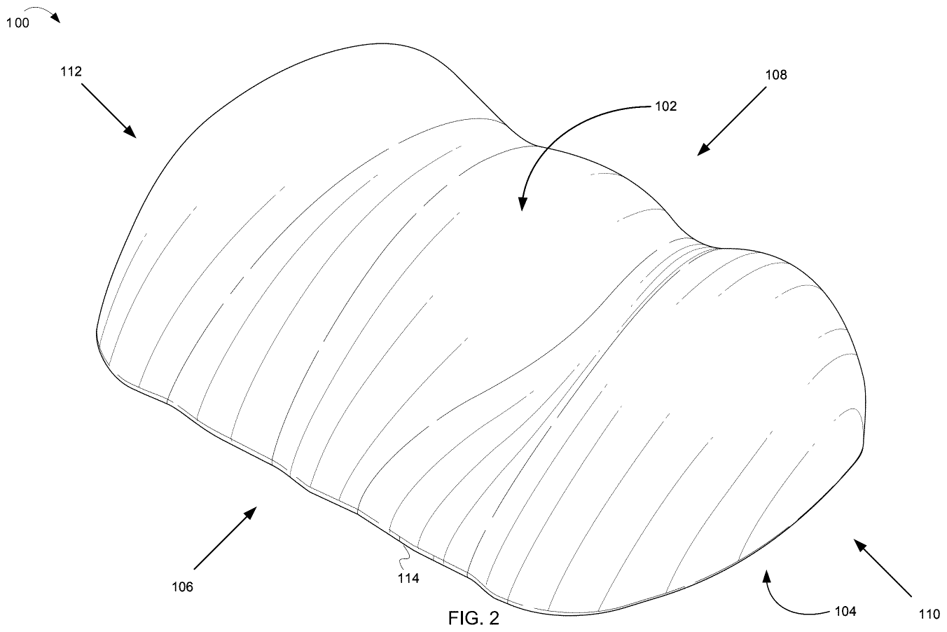

FIG. 2 is a top rear perspective view of an upper portion of a footrest, according to some implementations. FIG. 2 depicts the upper portion 100, including the top surface 102, the bottom surface 104, the back side 106, the front side 108, the right side 110, the left side 112, and the edge 114.

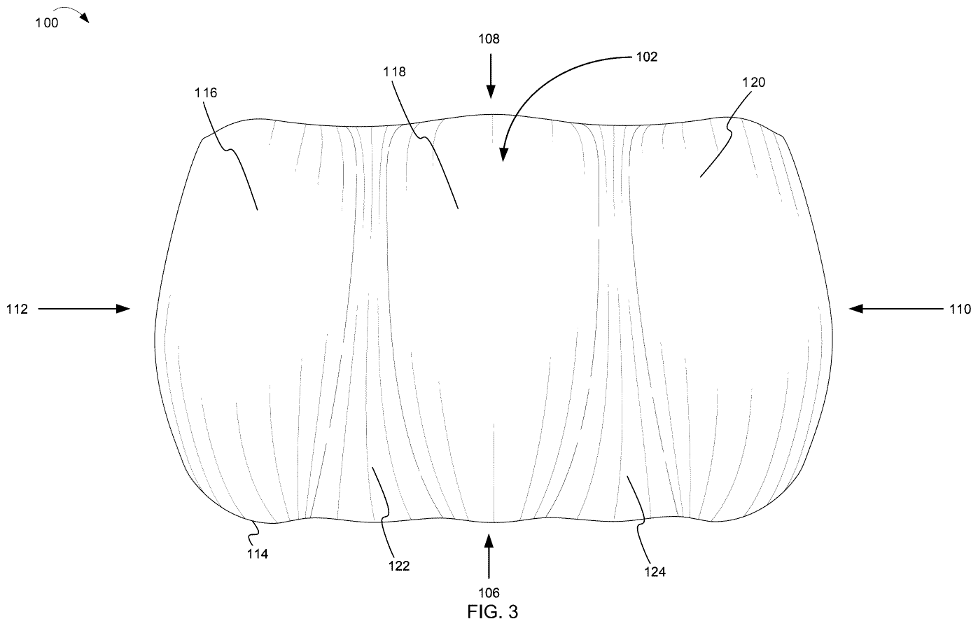

FIG. 3 is a top view of an upper portion of a footrest, according to some implementations. FIG. 3 depicts the upper portion 100, including the top surface 102, the back side 106, the front side 108, the right side 110, the left side 112, and the edge 114. The top surface 102 comprises a plurality of lobes 116, 118, and 120 and a plurality of interstitial portions 122 and 124. Each interstitial portion 122 and 124 is located between two of the plurality of lobes, creating a continuous, contoured top surface 102. In this example, the top surface 102 comprises a series of concave and convex surfaces, with the plurality of lobes 116, 118, and 120 forming the convex surfaces and the plurality of interstitial portions 122 and 124 forming the concave surfaces.

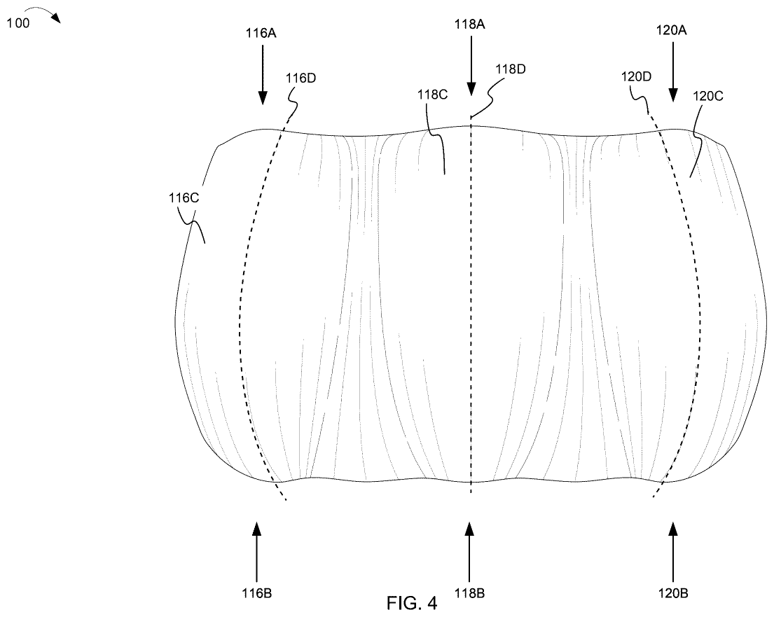

FIG. 4 is a top view of an upper portion of a footrest, according to some implementations. FIG. 4 depicts the components of the plurality of lobes 116, 118, and 120. In particular, each lobe of the plurality of lobes 116, 118, and 120 includes a front end and back end corresponding to the front side 108 and the back side 106, respectively, of the upper portion 100. In particular, a first lobe 116 includes a front end 116A and a back end 116B, with a contoured surface 116C formed between the front end 116A and the back end 116B; a second lobe 118 includes a front end 118A and a back end 118B, with a contoured surface 118C formed between the front end 118A and the back end 118B; a third lobe 120 includes a front end 120A and a back end 120B, with a contoured surface 120C formed between the front end 120A and the back end 120B.

Further, the first lobe 116 includes a centerline 116D that runs along the center of the first lobe from the front end 116A to the back end 116B and follows the contours of the contoured surface 116C; the second lobe 118 includes a centerline 118D that runs along the center of the second lobe from the front end 118A to the back end 118B and follows the contours of the contoured surface 118C; and the third lobe 120 includes a centerline 120D that runs along the center of the third lobe from the front end 120A to the back end 120B and follows the contours of the contoured surface 120C.

As depicted in FIG. 4, each lobe of the plurality of lobes 116, 118, and 120 can vary in shape. For example, the second lobe 118 is generally symmetrical about the centerline 118D. The first lobe 116 and the second lobe 120, however, are generally asymmetrical, with the contours curving such that the first lobe 116 and the third lobe 120 give the right side 110 and the left side 112 convex shapes, resulting in centerlines 116D and 120D curving similarly.

The front end 118A of the second lobe 118 is slightly rounded and the contoured surface 118C tapers into a rounded point at the back end 118B. Although the front end 118A and the back end 118B are rounded, the front end 118A is blunt relative to the back end 118B. The contoured surface 116C of the first lobe 116 and the contoured surface 120C of the third lobe 120 have a shape similar to the second lobe 118 but include bulges to the outside (the side opposite of the second lobe 118).

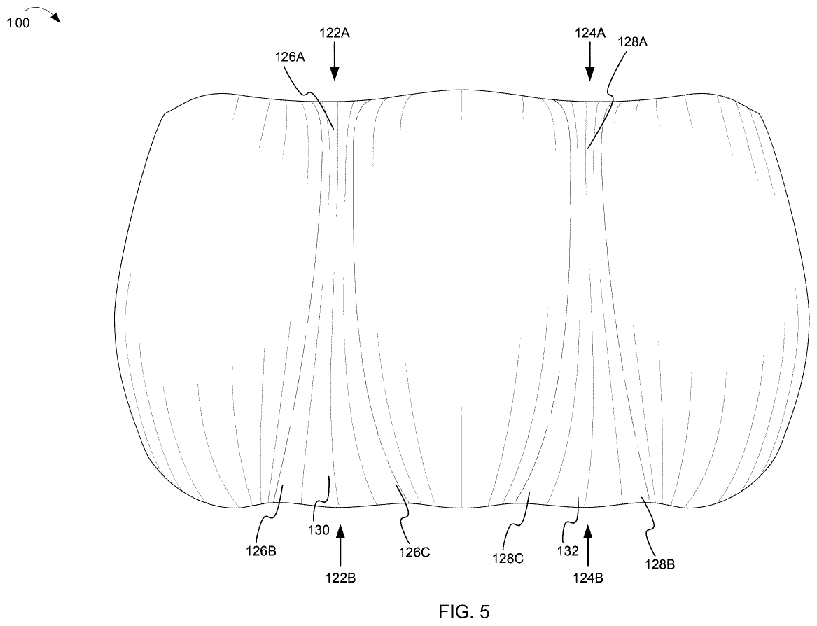

FIG. 5 is a top view of an upper portion of a footrest, according to some implementations. FIG. 5 depicts the plurality of interstitial portions 122 and 124 and components thereof. Each interstitial portion of the plurality of interstitial portions 122 and 124 includes a front end corresponding to the front side 108 of the upper portion 100 and a back end corresponding to the back side 106 of the upper portion 100. In particular, a first interstitial portion 122 includes a front end 122A and a back end 122B and a second interstitial portion 124 includes a front end 124A and a back end 124B.

Because the interstitial portions fill in the areas (interstices) between each of the plurality of lobes 116, 118, and 120, they form contoured channels between the individual lobes. In particular, the first interstitial portion 122 forms a first channel 126 between the first lobe 116 and the second lobe 118 and the second interstitial portion 124 forms a second channel 128 between the second lobe 118 and the third lobe 120. The edges of the first channel 126 follow the contoured surface 116C and contoured surface 118C while the edges of the second channel 128 follow the contoured surface 118C and the contoured surface 120C.

In this example, the channels created by the interstitial portions widen and split towards the back end of the interstitial portion. In particular, the first channel 126 begins as a single channel 126A and then splits as the distance between the first lobe 116 and the second lobe 118 increases towards their respective back ends, creating channels 126B and 126C. A first interstitial protrusion 130 separates channels 126B and 126C. Similarly, the second channel 128 begins as a single channel 128A and then splits as the distance between the second lobe 118 and the third lobe 120 increases towards their respective back ends, creating channels 128B and 128C. A second interstitial protrusion 132 separates channels 128B and 128C.

As described in further detail below, the boundaries between each of the plurality of lobes 116, 118, and 120 and each of the plurality of interstitial portions 122 and 124 can be the inflection point between the convex surface of a lobe and the concave surface of an interstitial portion. Further, although the interstitial protrusions described in this example are also a convex surface, they are considered part of the interstitial portions.

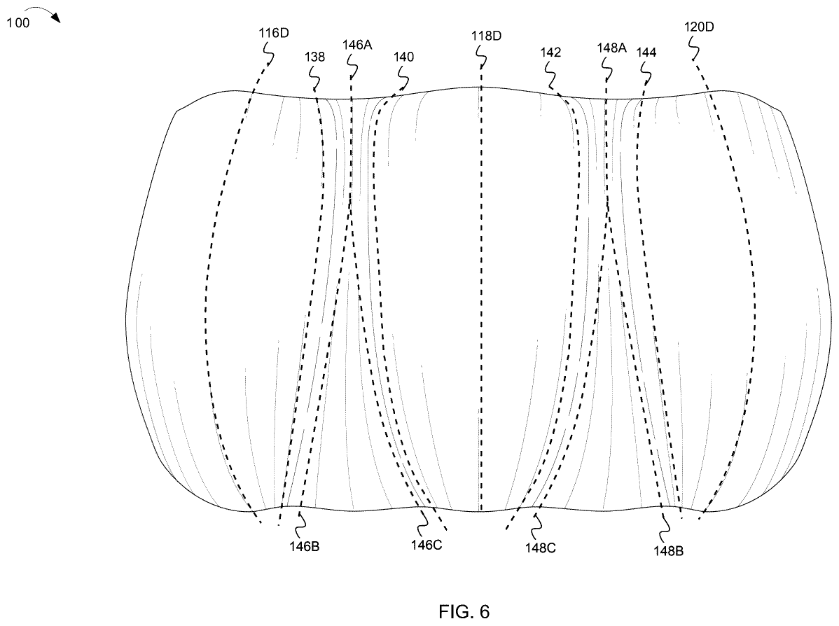

FIG. 6 is a top view of an upper portion of a footrest, according to some implementations. FIG. 6 depicts the upper portion 100 and the approximate boundaries between the plurality of lobes 116, 118, and 120 and the plurality of interstitial portions 122 and 124. In particular, line 138 depicts the approximate boundary (e.g., inflection point) between the first lobe 116 and the first interstitial portion 122; line 140 depicts the approximate boundary (e.g., inflection point) between the first interstitial portion 122 and the second lobe 118; line 142 depicts the approximate boundary (e.g., inflection point) between the second lobe 118 and the second interstitial portion 124; and line 144 depicts the approximate boundary (e.g., inflection point) between the second interstitial portion 124 and the third lobe 120.

FIG. 6 further depicts the approximate locations of the highest point lines (e.g., centerlines) of the plurality of lobes 116, 118, and 120. In particular, line 116D depicts the approximate location of the highest points along the length of the first lobe 116; line 118D depicts the approximate location of the highest points along the length of the second lobe 118; and line 120D depicts the approximate location of the highest points along the length of the third lobe 120.

FIG. 6 further depicts the approximate locations of the lowest point lines of the channels of the plurality of interstitial portions 122 and 124. In particular, line 146A depicts the lowest point of channel 126A, line 146B depicts the lowest point of channel 126B, and line 146C depicts the lowest point of channel 126C; and line 148A depicts the lowest point of channel 128A, line 148B depicts the lowest point of channel 128B, and line 148C depicts the lowest point of channel 128C.

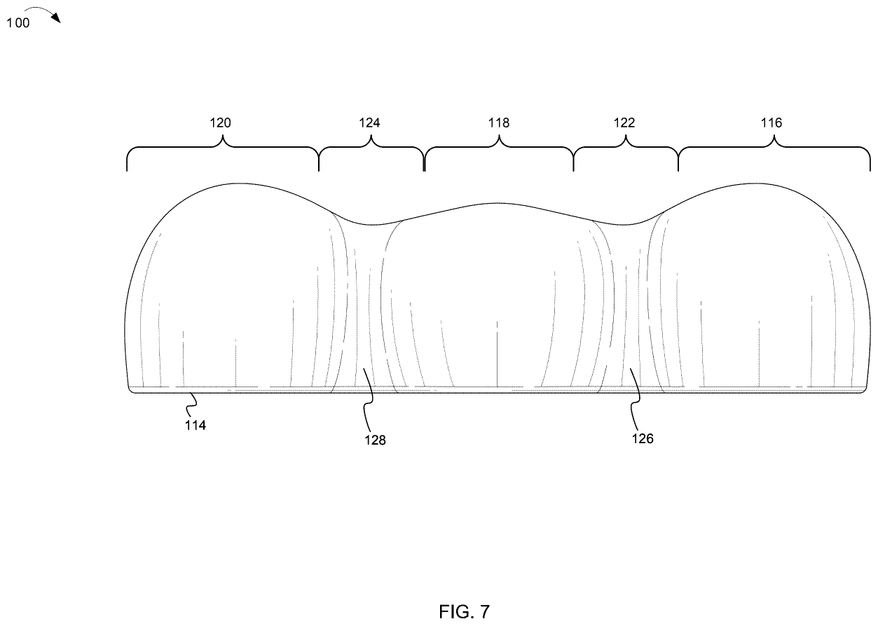

FIG. 7 is a front view of an upper portion of a footrest, according to some implementations. FIG. 7 depicts the upper portion 100, the plurality of lobes 116, 118, and 120 and the plurality of interstitial portions 122 and 124 based on their approximate boundaries. The plurality of lobes 116, 118, and 120 as well as the first channel 126 and the second channel 128 extend down the front side 108 to the edge 114. The height of the top surface 102 forms alternating high points and low points, with the high points corresponding to the centerline of each of the plurality of lobes 116, 118, and 120 and the low points corresponding to the low points of the plurality of interstitial portions 122 and 124 (i.e., the low point of the first channel 126 and the low point of the second channel 128).

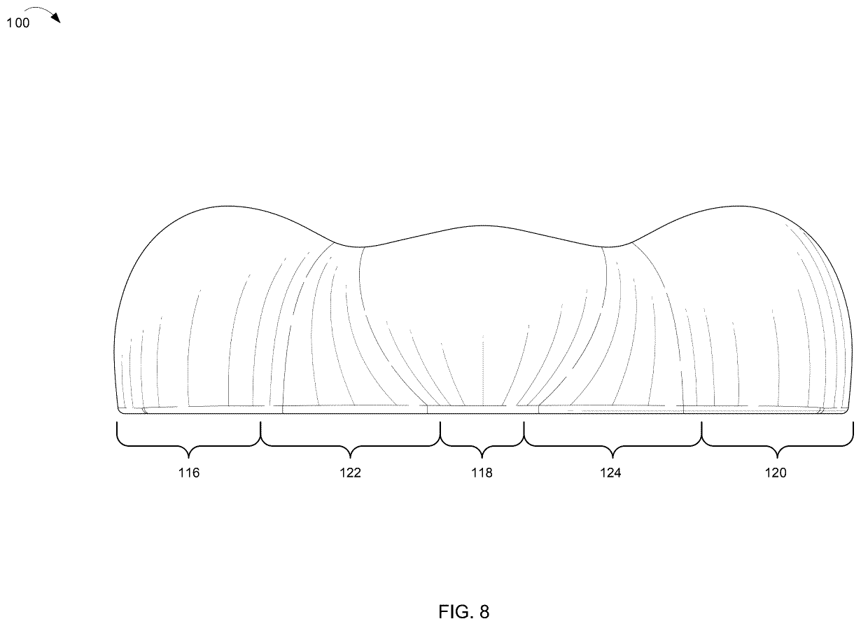

FIG. 8 is a back view of an upper portion of a footrest, according to some implementations. FIG. 8 depicts the plurality of lobes 116, 118, and 120 and the plurality of interstitial portions 122 and 124, based on their approximate boundaries. Comparing the front view of FIG. 7 with the back view of FIG. 8, the relative widths of the plurality of lobes 116, 118, and 120 to the plurality of interstitial portions 122 and 124 decreases from the front side 108 to the back side 106. In particular, each of the plurality of interstitial portions 122 and 124 widens relative to each of the plurality of lobes 116, 118, and 120 as the plurality of lobes 116, 118, and 120 narrow toward the back side 106. Further, the plurality of interstitial portions 122 and 124 sweep around the second lobe 118 as it narrows more than the first lobe 116 and third lobe 120.

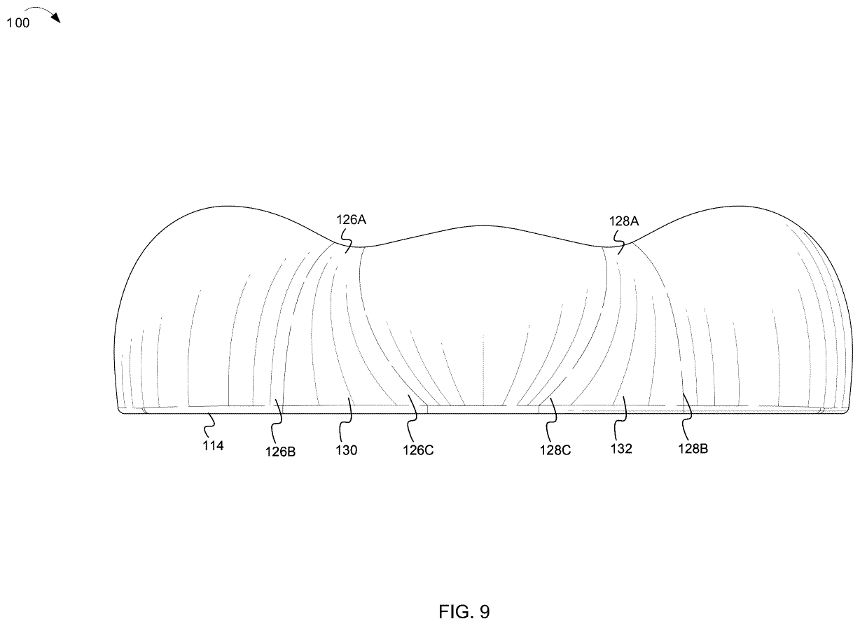

FIG. 9 is a back view of an upper portion of a footrest, according to some implementations. FIG. 9 depicts the components of the first channel 126, including channel, channel 126B, and channel 126C, and components of the second channel 128, including channel 128A, channel 128B, and channel 126C. FIG. 9 also depicts the first interstitial protrusion 130 and the second interstitial protrusion 132.

The plurality of lobes 116, 118, and 120 as well as the first channel 126 and the second channel 128 extend down the back side 106 to the edge 114, thus extending from the edge 114 on the front side 108 to the edge 114 on the back side 106. The first interstitial protrusion 130 and the second interstitial protrusion 132, however, do not extend to the edge 114 on the front side 108, instead extending from where the first channel 126 and the second channel 128 split to the edge 114 on the back side 106.

Because the contoured surface 118C of the second lobe 118 sweeps inward more than the contoured surface 116C of the first lobe 116 and the contoured surface 120C of the second lobe 120, the first channel 126 and the second channel 128 also sweep inward, hugging the edge of the contoured surface 118C as it tapers to the back end 118B of the second lobe 118.

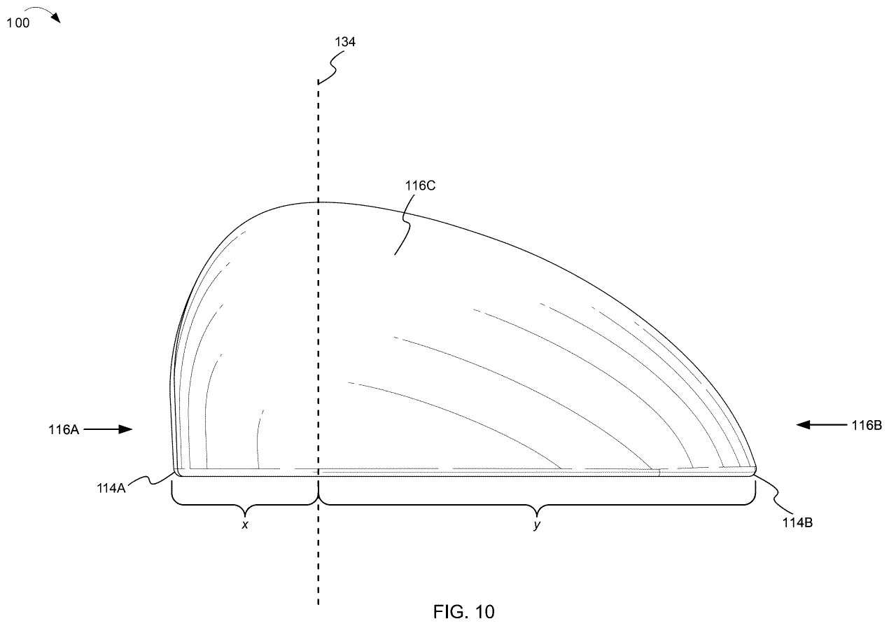

FIG. 10 is a left side view of an upper portion of a footrest, according to some implementations. FIG. 10 depicts the first lobe 116, including the front end 116A, the back end 116B, the contoured surface 116C, and the edge 114. As described above, the front end 116A of the first lobe 116 is slightly rounded and the contoured surface 116C tapers into a point at the back end 116B, with the front end 116A being flattened or blunt relative to the back end 116B. The contoured surface begins at the front edge 114A and ends at the back edge 114B.

Highest point line 134 identifies the highest point of the first lobe 116, x is the distance from the front edge 114A to the highest point line 134, and y is the distance from the highest point line 134 to the back edge 114B. In this example, the ratio of x to y is approximately ⅓, although implementations can vary.

The second lobe 118 and the third lobe 120 may have a similar profile but, as noted above, may have differing heights.

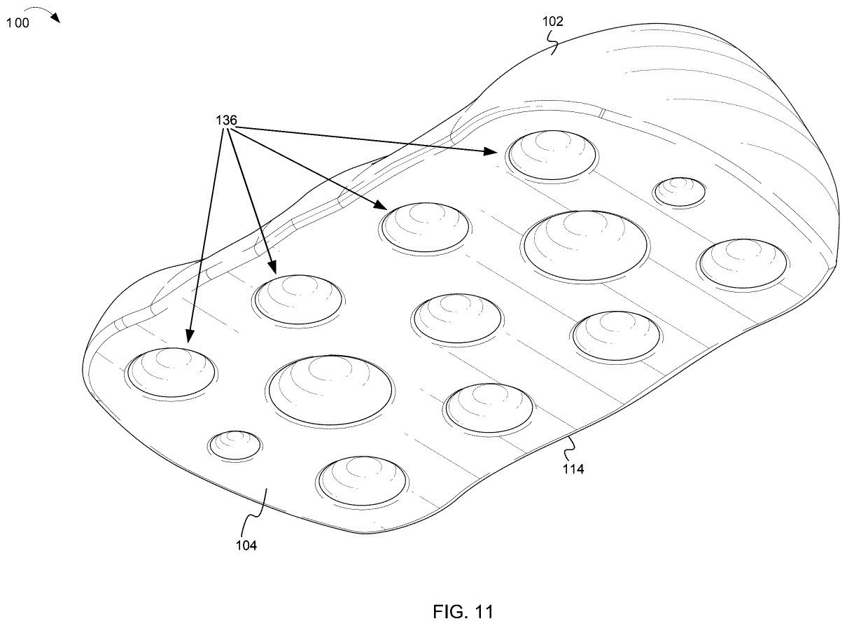

FIG. 11 is a bottom rear perspective view of an upper portion of a footrest, according to some implementations. FIG. 11 depicts the top surface 102, the bottom surface 104, the edge 114, and a set of one or more hemispherical indentations 136. The bottom surface 104 is generally a planar surface but may include various elements that assist in mating the upper portion 100 to a lower portion of a footrest, like the hemispherical indentations 136. As noted above, the top surface 102 and the bottom surface 104 meet at the edge 114. The edge 114 may be rounded, as depicted here, as the top surface 102 transitions to the bottom surface 104. Other implementations may have a sharper edge or a more rounded edge.

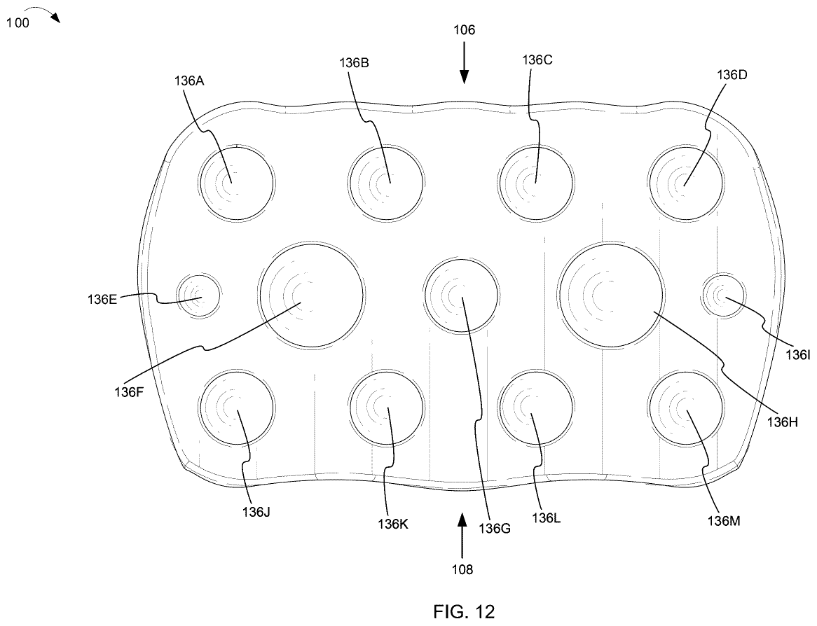

FIG. 12 is a bottom view of an upper portion of a footrest, according to some implementations. FIG. 12 depicts the bottom surface 104, the edge 114, and the set of one or more hemispherical indentations 136. In this example, the hemispherical indentations 136 are arranged in three rows, are staggered vertically, and come in three different sizes. In particular, the back row (relative to the back side 106) consists of four hemispherical indentations 136A, 136B, 136C, and 136D, all having a first size; the middle row consists of five hemispherical indentations 136E, 136F, 136G, 136H, and 136I, with 136G having the first size, 136E and 136I having a second size that is smaller than the first size, and 136F and 136H having a third size that is larger than the first size; and the front row (relative to the front side 108) consists of four hemispherical indentations 136J, 136K, 136L, and 136M, all having the first size.

As described in more detail below, the hemispherical indentations 136, and alternative embodiments of the like, can help the upper portion 100 mate with a lower portion.

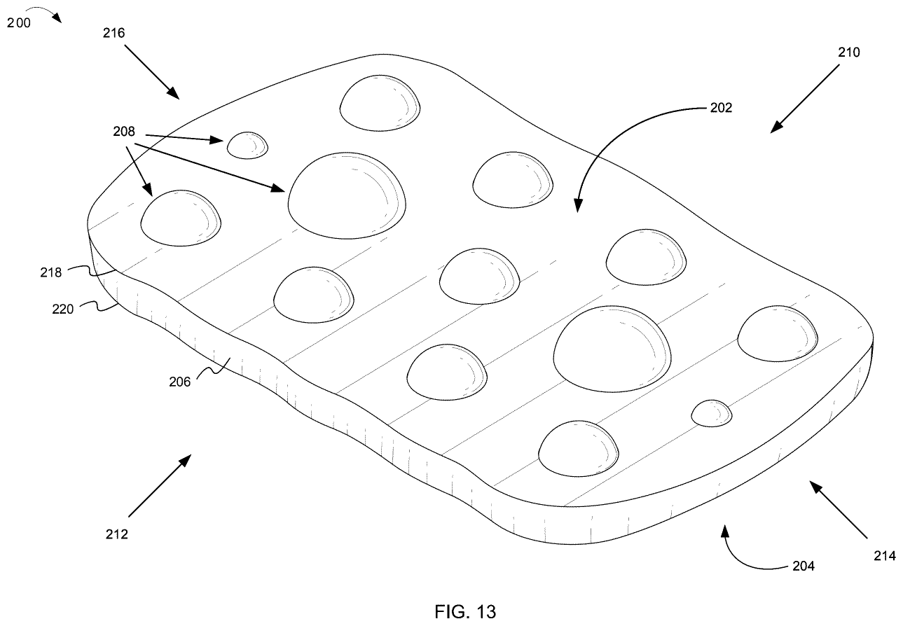

FIG. 13 depicts a top rear perspective view of a bottom portion of a footrest, according to some implementations. FIG. 13 depicts a bottom portion of a footrest 200 (“bottom portion 200”) that comprises a top surface 202, a bottom surface 204, a side surface 206, and a plurality of hemispherical protrusions 208. The bottom portion 200 has a front side 210, a back side 212, a right side 214, a left side 216. The perimeter of the top surface 202 forms an upper edge 218 and the perimeter of the bottom surface 204 forms a lower edge 220. The side surface 206 extends between the upper edge 218 and the lower edge 220. The top surface 202 is substantially planar except for the addition of the hemispherical protrusions 208. The top surface 202 may have a shape that matches the contours of the bottom surface 104 of the upper portion 100 as described in more detail below. The bottom surface 204 may have a similar shape to the top surface 202, with the side surface 206 thus having a shape that corresponds to the shape of the bottom surface 204 and the top surface 202. In cases where the top surface 202 and the bottom surface 204 have different shapes, the side surface 206 may form a transition between the shape of the top surface 202 and the shape of the bottom surface 204, thus having a shape that is a composite thereof.

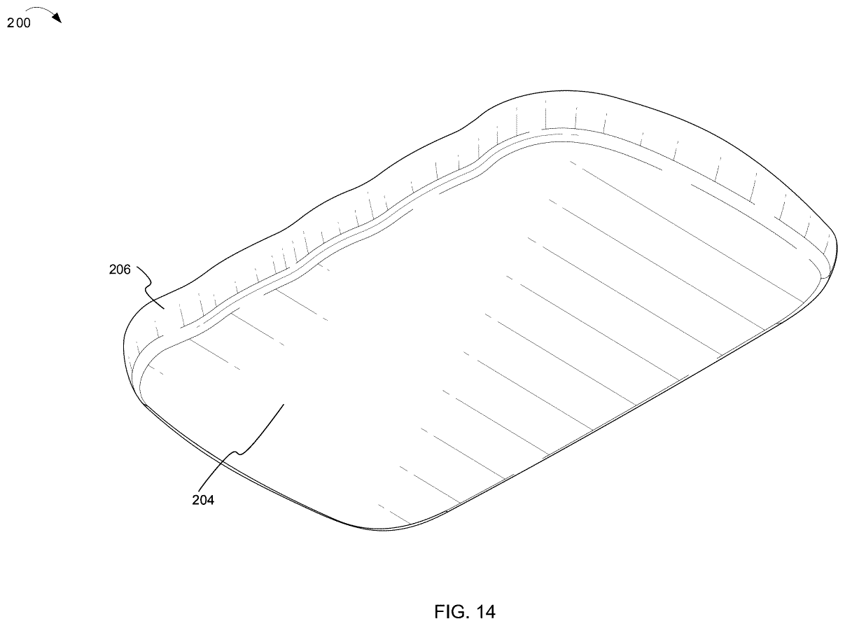

FIG. 14 depicts a bottom rear perspective view of a bottom portion of a footrest, according to some implementations. FIG. 14 depicts the lower portion 200, including the bottom surface 204 and the side surface 206. The bottom surface 204 is substantially planar and, as described above, may have a shape that matches the top surface 202.

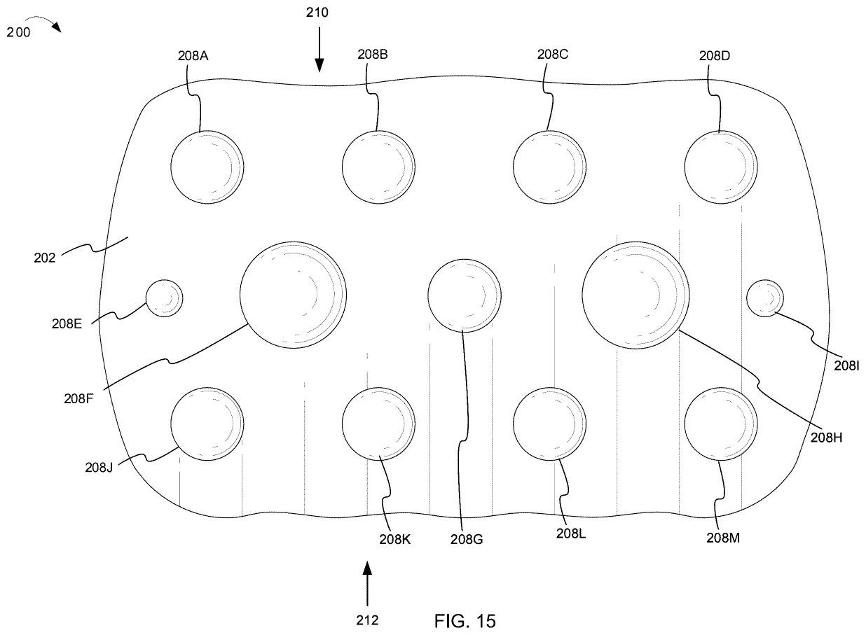

FIG. 15 depicts a top view of a lower portion of a footrest, according to some implementations. FIG. 15 depicts the top surface 202 and the plurality of hemispherical protrusions 208. In this example, the hemispherical protrusions 208 match the hemispherical indentations 136. In particular, the hemispherical protrusions 208 are arranged in three rows with protrusions of three differing sizes; a back row (relative to the back side 212) of the hemispherical protrusions 208 consists of four hemispherical protrusions 208A, 208B, 208C, and 208D of a first size; a middle row of the hemispherical protrusions 136 consists of five hemispherical protrusions 208E, 208F, 208G, 208H, and 208I, with 208G having the first size, 208E and 208I having a second size that is smaller than the first size, and 208F and 208H having a third size that is larger than the first size; a front row (relative to the front side 210) of the hemispherical protrusions 208 consists of four hemispherical protrusions 208J, 208K, 208L, and 208M of the first size.

In this example, the first size of the hemispherical protrusions 208 matches the first size of the hemispherical indentations 136, the second size of the hemispherical protrusions 208 matches the second size of the hemispherical indentations 136, and the third size of the hemispherical protrusions 208 matches the third size of the hemispherical indentations 136.

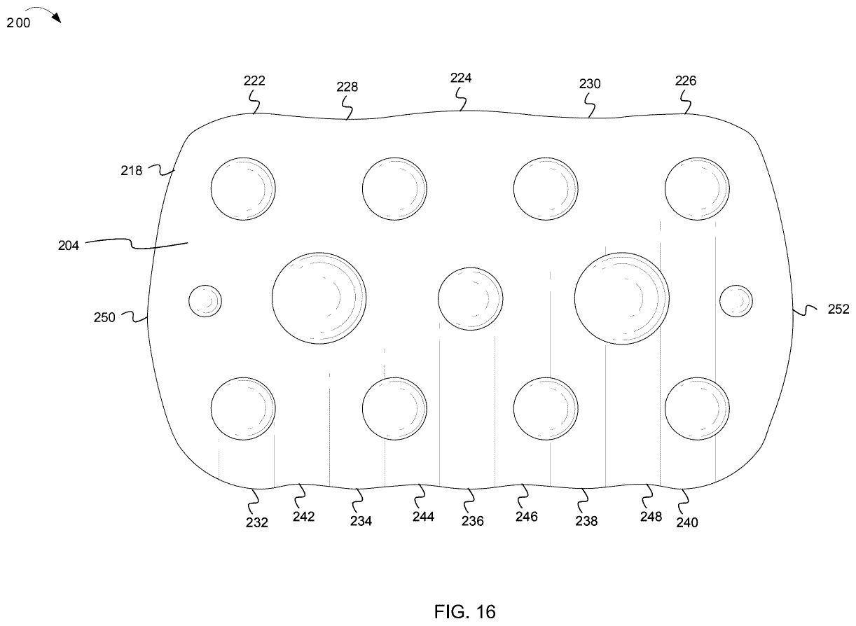

FIG. 16 depicts a top view of a lower portion of a footrest, according to some implementations. FIG. 16 depicts the top surface 202 and the upper edge 218. As described above, the top surface 202, and therefore the upper edge 218, can have a shape that matches the bottom surface 104 of the upper portion 100 and the edge 114. Thus, in this example, the front side of the upper edge 218 includes three protrusions 222, 224, and 226 that correspond to the first lobe 116, the second lobe 118, and the third lobe 120, respectively, and two channels 228 and 230 that correspond to the first interstitial portion 122 and the second interstitial portion 124, respectively. Similarly, the rear side of the upper edge 218 includes five protrusions 232, 234, 236, 238, and 240, corresponding the three lobes 116, 118, and 120 and the two interstitial protrusions 130 and 132, as well as four channels 242, 244, 246, and 248 that correspond to the four channels 126B, 126C, 128B, and 128C.

The right side and left side of the upper edge 218 also include rounded protrusions (or “bulges”) that match the shapes of the first lobe 116 and the third lobe 120. The lower edge 220, in this example, has a similar shape to that of the upper edge 218.

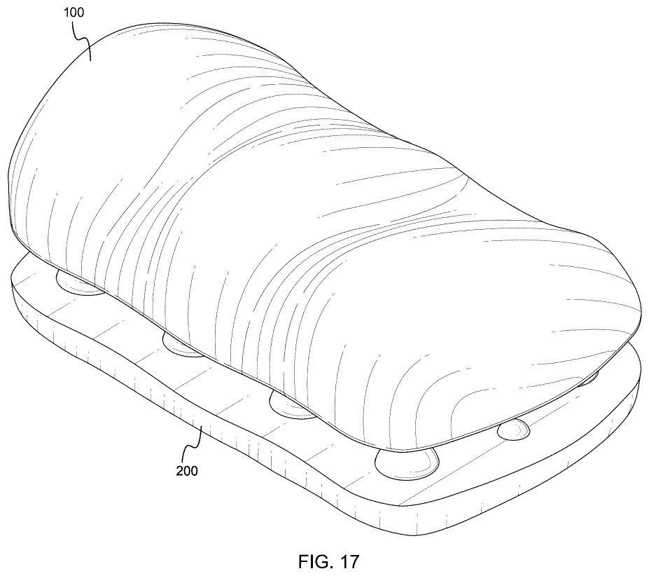

FIG. 17 depicts a top front perspective view of an upper portion and lower portion of a footrest, according to some implementations. FIG. 17 depicts the upper portion 100 and the lower portion 200, illustrating that the upper portion 100 can be placed onto the lower portion 200. In this example, the one or more hemispherical indentations 136 are aligned with the one or more hemispherical protrusions 208, allowing the bottom surface 104 of the upper portion 100 to come into contact with the top surface 202 of the lower portion 200.

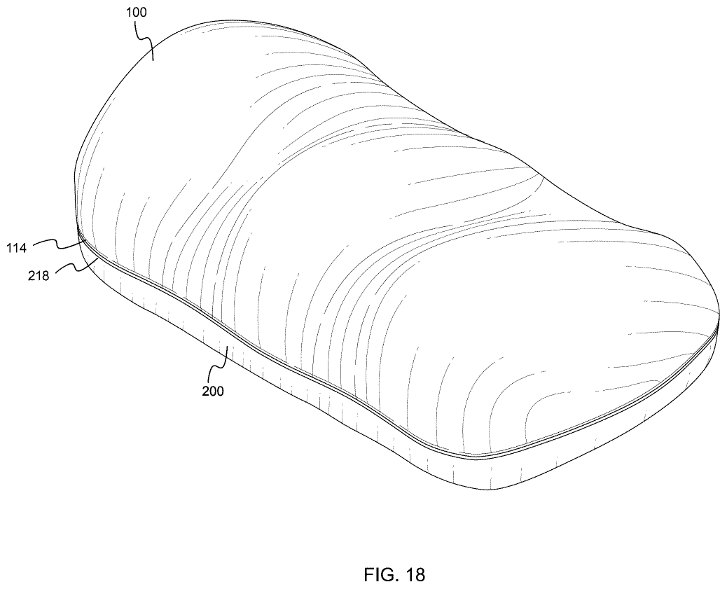

FIG. 18 depicts a top front perspective view of an upper portion of a footrest placed on a lower portion of the footrest, according to some implementations. FIG. 18 depicts the upper portion 100 and the lower portion 200. The upper portion 100 has been placed such that the bottom surface 104 of the upper portion 100 is in contact with the top surface 202 of the lower portion 200. As such, the upper portion 100 sits flush with the lower portion 200. Further, because the bottom surface 104 of the upper portion 100 and the top surface 202 of the lower portion 200 have matching shapes, the upper edge 218 of the lower portion 200 matches the edge 114 of the upper portion 100.

As noted above, the edges (e.g., the edge 114 of the upper portion 100 and the upper edge 218 of the lower portion 200) may be rounded, thus leaving a small gap between the upper portion 100 and the lower portion 200 along the respective outside edges. As such, the bottom surface 104 of the upper portion 100 may not contact the top surface 102 of the lower portion 200 all the way to the edge.

The upper portion 100 and the lower portion 200 may be made with various materials and using various construction methods. For example, the upper portion 100 and lower portion 200 may be constructed of foam of various densities, plastic, etc. For example, the upper portion 100 and the lower portion 200 may be constructed of hard foam, soft foam, or a combination thereof (e.g., a hard foam core with a soft foam outside or hard foam in certain locations and soft foam in other locations). As another example, the upper portion 100 and the lower portion 200 may be constructed of plastic (e.g., using injection molding, 3D printing, etc.) or may be constructed of a plastic core with a foam exterior.

The upper portion 100 and the lower portion 200 may be constructed similarly to each other or differently. For example, the upper portion 100 may be constructed of soft foam while the lower portion 200 may be constructed of hard foam or plastic.

By separating the footrest into the upper portion 100 and the lower portion 200, the footrest becomes height-adjustable, allowing the footrest to fit the ergonomics of a wider number of users. The hemispherical protrusions 208 support the coupling of the upper portion 100 with the lower portion 200 by acting as a retaining mechanism when coupled with the hemispherical indentations 136. In particular, the hemispherical protrusions 208 engage with the hemispherical indentations 136 and prevent the upper portion 100 from sliding off the lower portion 200, as might occur if the bottom surface 104 of the upper portion 100 and the top surface 202 of the lower portion 200 were flat.

The hemispherical protrusions 208 further serve as a physical therapy device, providing a pressure source for the massaging of feet and other body parts, activating trigger points, etc. Thus, instead of the lower portion 200 being limited to height adjustment of the footrest, the lower portion 200 is independently usable as a physical therapy device.

Variations of the examples herein can support the varying aspects of the aforementioned functionality. For example, the hemispherical protrusions 208 can be constructed using materials of varying density so that the user can customize the amount of pressure exerted when used as a physical therapy device. As another example, some or all of the hemispherical protrusions 208 may be replaced with one or more protrusions of different shapes (e.g., pyramidal, toroidal, tubular) and the number and arrangement of the protrusions may vary. As another example, the lower portion 200 may have tubular protrusions arranged in various orientations along the top surface 202 with corresponding tubular indentations in the bottom surface 104 of the upper portion 100.

Alternatively, some implementations may have the protrusions on the bottom surface 104 of the upper portion 100 and the indentations on the top surface 202 of the lower portion 200 or a combination thereof.

The examples herein depict the arrangement of protrusions/indentations as symmetrical. As such, if the upper portion 100 was rotated 180 degrees about the vertical axis and placed on the lower portion 200, the bottom surface 104 of the upper portion 100 would still contact the top surface 202 of the lower portion 200. However, in some implementations the protrusions and indentations may be arranged in a non-symmetrical manner such that when the upper portion 100 is rotated 180 degrees about the vertical axis the upper portion 100 sits on top of the protrusions instead of the protrusions engaging with the indentations. Such an implementation may result in the upper portion 100 being at a third height level, providing additional height adjustability.

In such implementations, an arrangement of protrusions and indentations can be used that still results in the protrusions engaging with the indentations and acting as a retaining mechanism while keeping a third height option. For example, the arrangement of protrusions may include shallower indentations which, when the upper portion 100 is rotated 180 degrees relative to the lower portion 200, fit on the upper portion of larger protrusions.

Although the descriptions herein describe a particular example, the example is for illustrating the inventive subject matter and embodiments of the inventive subject matter may vary from the example described herein while still falling within the inventive subject matter. Some possible variations to the examples are described below but the inventive subject matter is not limited to the following variations.

Although the examples herein relate to a footrest, the inventive subject matter is not so limited and it is understood that the inventive subject matter described herein is intended to cover any apparatus, process, etc. that has the characteristics described herein.

While the example depicted herein features three lobes and two interstitial portions, implementations may vary. For example, other implementations may have a single lobe with no interstitial portions, two lobes with one interstitial portion, or more than three lobes with one fewer interstitial portions than lobes. Further, some implementations may include portions to the outside of the outermost lobes that are similar to the interstitial portions. For example, multiple cushions may be manufactured from a large, single piece that includes a number of lobes and interstitial portions which is then cut into smaller portions between lobes, resulting in the outermost sides of the cushion being one half of a full interstitial portion.

It is understood that implementations of the inventive subject matter described herein may have lobes of uniform shape, lobes that have variable shape, or a combination thereof. Similarly, some implementations may have lobes with different proportions than depicted in the examples. For example, instead of having a front end that is blunt relative to the back end, some implementations may have lobes that are more symmetrical or a combination of symmetrical and asymmetrical lobes.

It is further understood that defining the boundaries between each of the lobes and each of the interstitial portions as being the inflection point between the convex surface of a lobe and the concave surface of an interstitial portion is convenient but not a necessity. For example, in some embodiments the lobes and the interstitial portions may be made of different materials, have different attributes, etc., and thus defining the boundaries between the lobes and the interstitial portions differently may be more convenient. Further, some implementations may not feature a continuous surface, thus making it more convenient to define the boundary based on discontinuities of the surface. Regardless, implementations of the inventive subject matter herein are not limited to ones that have an inflection point between a convex and concave surface serving as a boundary.

It is further understood that implementations of the inventive subject matter described herein can include lobes of varying heights or lobes with uniform heights.

It is understood that the inventive subject matter herein includes, but is not limited to, one or more apparatuses (e.g., a footrest and/or portions thereof), one or more systems (e.g., a footrest and/or portions thereof), one or more processes, including the manufacturing and/or use of a footrest or portion thereof.

As used herein, the term “or” is inclusive unless otherwise explicitly noted. Thus, the phrase “at least one of A, B, or C” is satisfied by any element from the set {A, B, C} or any combination thereof, including multiples of any element.

While the aspects of the disclosure are described with reference to various implementations and exploitations, it will be understood that these aspects are illustrative and that the scope of the claims is not limited to them. In general, footrests, techniques for manufacturing and using footrests, etc. as described herein may be implemented with various means and techniques. Many variations, modifications, additions, and improvements are possible.

1. A article of manufacture comprising:
an upper portion having a first top surface and a first bottom surface, wherein the first top surface and the first bottom surface meet at a first edge having a front side and back side, wherein the top surface comprises a first lobe and a first interstitial portion, wherein the first lobe and the first interstitial portion extend from the front side of the first edge to the back side of the first edge.

2. The article of manufacture of claim 1, wherein the first edge has a shape corresponding to the first lobe and the first interstitial portion.

3. The article of manufacture of claim 2, wherein the first edge having a shape that corresponds to the first lobe and the first interstitial portion comprises the first edge having a first protrusion where the first lobe meets the front side, a first channel where the first interstitial portion meets the front side, a second protrusion where the first lobe meets the back side, and a second channel where the interstitial portion meets the back side.

4. The article of manufacture of claim 1, further comprising a lower portion having a second top surface, a second bottom surface, and a side surface formed between an edge of the second top surface and an edge of the second bottom surface.

5. The article of manufacture of claim 4, wherein the first bottom surface includes a plurality of indentations and wherein the second top surface includes a plurality of protrusions configured to mate with the plurality of indentations.

6. The article of manufacture of claim 1, wherein the first lobe forms a convex portion of the top surface and the first interstitial portion forms a concave portion of the top surface.

7. The article of manufacture of claim 1, wherein the first lobe has a front end and a back end and wherein the first lobe tapers from the front end to the back end.

8. An article of manufacture comprising:
a first portion, the first portion comprising:
a first top surface comprising a plurality of lobes and one or more interstitial portions between the plurality of lobes, wherein the first top surface is contoured;
a first bottom surface, wherein the first bottom surface is substantially planar; and
a first edge defined by the intersection of the first top surface and the first bottom surface, the first edge having a front edge portion, a back edge portion, a right edge portion, and a left edge portion, wherein each lobe of the plurality of lobes and each interstitial portion of the one or more interstitial portions extends from the front edge portion to the back edge portion.

9. The article of manufacture of claim 8, wherein each lobe of the plurality of lobes corresponds to a convex portion of the first top surface and each interstitial portion of the one or more interstitial portions corresponds to a concave portion of the first top surface.

10. The article of manufacture of claim 9, wherein a first interstitial portion of the one or more interstitial portions comprises a first channel coupled with a second channel and a third channel, wherein the second channel and the third channel are separated by an interstitial protrusion.

11. The article of manufacture of claim 10, wherein the first channel, the second channel, and the third channel form concave portions of the first top surface and the interstitial protrusion forms a convex portion of the first top surface.

12. The article of manufacture of claim 8, wherein the first bottom surface includes a plurality of indentations.

13. The article of manufacture of claim 8, further comprising a second portion, the second portion comprising:
a second top surface, wherein the second top surface is substantially planar;
a second bottom surface, wherein the second bottom surface is substantially planar; and
a side surface extending from an edge of the second top surface to an edge of the second bottom surface.

14. The article of manufacture of claim 13, wherein the first bottom surface includes a plurality of indentations and wherein the second top surface includes a plurality of protrusions, wherein the plurality of indentations is configured to mate with the plurality of protrusions.

15. A height-adjustable footrest comprising:
an upper portion having a contoured top surface and a substantially planar bottom surface, wherein the top surface and the bottom surface meet to form an edge;
a lower portion having a substantially planar top surface, a substantially planar bottom surface, and a side surface extending between the top surface of the lower portion and the bottom surface of the lower portion, wherein the height of the footrest is adjustable by placing the upper portion on the lower portion; and
a retaining mechanism configured to maintain the upper portion on the lower portion.

16. The height-adjustable footrest of claim 15, wherein the retaining mechanism comprises a plurality of indentations on the bottom surface of the upper portion and a plurality of protrusions on the top surface of the lower portion, wherein the plurality of indentations are configured to mate with the plurality of protrusions.

17. The height-adjustable footrest of claim 16, wherein the plurality of protrusions are usable as a physical therapy device.

18. The height-adjustable footrest of claim 15, wherein the lower portion is constructed using a first material and the upper portion is constructed using a second material.

19. The height-adjustable footrest of claim 18, wherein the first material is stiffer than the second material.

20. The height-adjustable footrest of claim 15, wherein the top surface of the upper portion comprises a plurality of alternating convex and concave segments that extend from a front portion of the edge to a back portion of the edge.
